(19) United States
(12) Patent Application Publication
(10) Pub. No.: US 2020/0290414 A1
(43) Pub. Date: Sep. 17, 2020

(54) ACCESSORY FOR TRAILER TOWING VEHICLE

(71) Applicant: Scot R. Moller, Corpus Christi, TX (US)

(72) Inventor: Scot R. Moller, Corpus Christi, TX (US)

(21) Appl. No.: 16/801,311

(22) Filed: Feb. 26, 2020

Related U.S. Application Data
(60) Provisional application No. 62/818,179, filed on Mar. 14, 2019.

(51) Int. Cl. B60D 1/64

(52) U.S. Cl. CPC B60D 1/64

(57) ABSTRACT

An accessory for an electrical receptacle on a towing vehicle provides a housing configured to mate with the receptacle. Terminals in the receptacle and the housing electrically connect to provide power to electronic components in the housing. The electronic components connect to a USB port exposed through the housing so a user may power USB devices from the electrical receptacle on the towing vehicle.

This application is based on Provisional Patent Application 62/818,179, entitled ACCESSORY FOR A TRAILER TOWING VEHICLE, filed Mar. 14, 2019, priority of which is claimed.

This invention relates to an accessory for a trailer towing vehicle that provides a USB port.

### BACKGROUND OF THE INVENTION

Trailer towing vehicles, such as trucks and SUVs, are equipped to pull trailers including such equipment as an electrical receptacle on the vehicle rear, usually on or near the bumper, into which a connection is inserted providing a cable connected to electrical components on the trailer. In this fashion, electrical power for the trailer is provided by the towing vehicle so trailers do not require a motor/generator set and battery and thus can be relatively cost efficient.

It occasionally occurs that it is desirable to use or charge a USB enabled device in unusual locations. Examples include working or partying off the end of a pickup truck or tailgate, parked in the outfield of a little league baseball game, on the beach, bird hunting, camping and the like. If batteries are low in a USB device or if DC current is needed for other purposes, the only common option is to use a cigarette lighter socket in the cab of the truck provided one has purchased a USB-to-cigarette lighter adapter which is not standard equipment for USB enabled devices.

It is known in the prior art to use a trailer connection as a source of electric power for a variety of purposes. Disclosures of interest are found in U.S. Pat. Nos. 9,093,773 and 9,375,987. In addition, a commercially available device has one end insertable into the truck receptacle and a second end having a pair of cigarette lighter ports.

### SUMMARY OF THE INVENTION

An accessory uses a vehicle mounted electrical receptacle normally used to supply power to a trailer. The accessory has one end configured to fit in and be powered by terminals in the vehicle's electrical receptacle. The accessory includes a second end having a USB port that can be used to provide electrical power to any USB enabled device such as a charging port for a cell phone.

### BRIEF DESCRIPTION OF THE DRAWINGS

FIG. 1 is a rear view of a trailer towing vehicle showing a more-or-less standard location of an electrical receptacle used to provide electrical power to a trailer;

FIG. 2 is an exploded view of an accessory providing an electrical path transmitting power from an electrical receptacle to a USB port;

FIG. 3 is a cross-sectional view of the accessory of FIG. 2;

FIG. 4 is a view of the end of the accessory that is inserted into the electrical receptacle;

FIG. 5 is a view of an opposite end of an accessory, similar to FIG. 4 but having a one piece housing, illustrating the USB port; and

FIG. 6 is a top view of the housing illustrating a guide rib orienting the accessory in a correct position in the trailer receptacle.

### DETAILED DESCRIPTION OF THE INVENTION

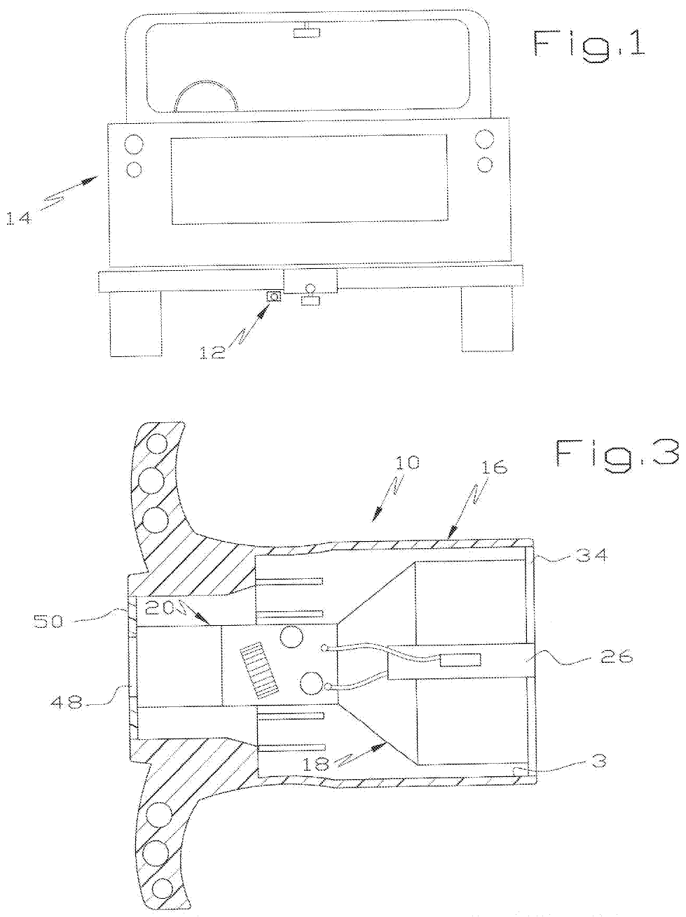

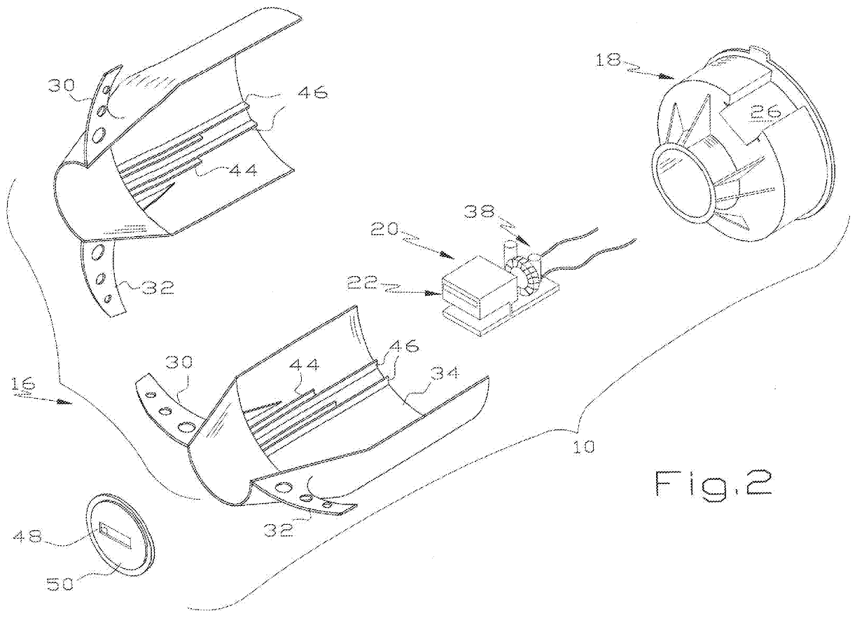

Referring to FIGS. 1-6, an accessory 10 is inserted into an electrical receptacle 12 mounted on or near the rear of a towing vehicle 14 such as a truck or SUV as shown in FIG. 1. The electrical receptacle 12 may be of conventional configuration, is commercially available at any major auto parts retailer and comes as standard equipment on most full sized pick up trucks and trailer towing equipped SUVs. The receptacle 12 includes a series of terminals (not shown) which supply power to a variety of devices on a trailer, such as lights, brake lights, signal lights and universally includes an electrically energized or hot terminal (not shown) and a ground terminal (not shown) at angular locations that are standard in the industry. The energized or hot terminal is a constant supply of power, meaning the vehicle engine does not have to be running or the key does not have to be in the “on” position. Details of the receptacle 12 may be found in the manuals of manufacturers.

The accessory 10 comprises, as major components, a housing 16, a fitting 18 configured to fit into the receptacle 12 and electrically connect to the hot terminal and ground terminal of the receptacle 12 and an electronic module 20 electrically connecting the fitting 18 to one or more USB ports 22 on an exterior of the module 20. The interior of the housing 16 is configured to receive, stabilize and captivate the fitting 18 and the electronic module 20 so they remain in position inside the housing 16.

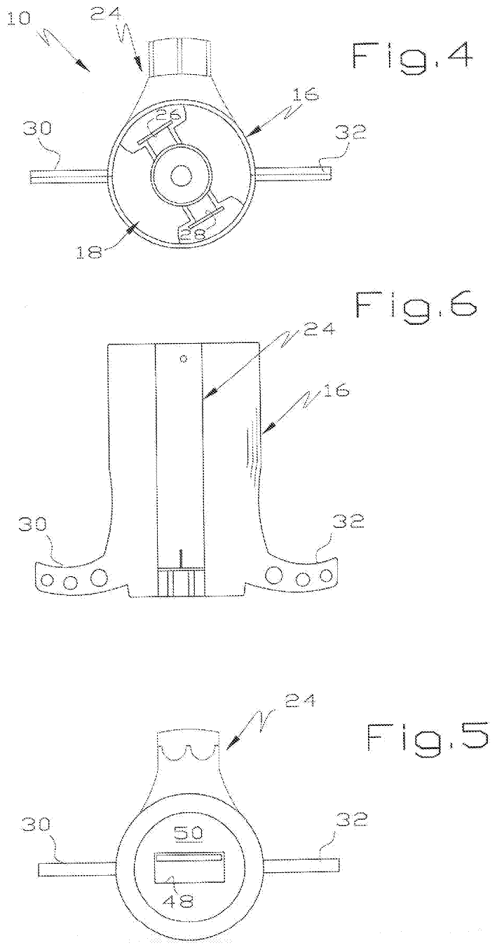

The housing 16 may be a multi-piece housing as shown in FIGS. 2 and 4 comprising mirror image halves secured together by suitable fasteners (not shown) or may be a one piece unitary housing, meaning the housing has no seams which are joined together, as suggested in FIG. 5. The housing 16 includes an external rib 24 orienting the housing 16 in a correct position to pass into the receptacle so the hot and ground terminals of the receptacle 12 align with and make electrical connection with conductive terminals 26, 28 in the fitting 18. This provides electrical power to the module 20 as will be more fully apparent hereinafter. It will be seen that one end of the accessory 10 is compatible with the receptacle 12 in the sense that it fits snugly into the receptacle 12 and makes connection with the hot and ground terminals. The housing 16 may include wings 30, 32 allowing a user to pull the accessory 10 from the receptacle 12.

The fitting 18 is made of an electrically insulating materials, typically plastic, and provides a lip 34 sized to snugly fit in a recess 36 at one end of the housing halves 28, 30. The terminals 26, 28 extend inwardly of the housing 16 for connection to the module 20.

The module 20 is of conventional design and includes electronic components 38 sufficient to convert an input of 12 or 24 volt dc into an output voltage which is compatible with commercially available USB enabled devices. Currently, the output voltage is 5 volts direct current but this may change as the industry evolves. The current passing through the electronic components is typically on the order of 1-5 amperes. The module 20 includes leads 40, 42 connected to the terminals 26, 28 as by soldering or the like. The module 20 is captivated and constrained against movement inside by the housing 16 by ribs or other projections 44, 46.

In its assembled condition, the USB port 22 of the module 20 extends through a slot 48 in an end cap 50 which is conveniently molded into a single piece housing 16 as in FIG. 4 or secured in any suitable fashion to separate housing pieces 16 as in FIGS. 2 and 4. It will be seen that the housing 16 is symmetrical about an axis extending from a first end received in the receptacle 12 and a second end including the slot 48. It will also be seen that the fitting 18, the module 20 and the slot 48 are in a line, i.e. linearly aligned.

To use the accessory 10, the user plugs the fitting 18 into the electrical receptacle 12 on the back of the vehicle 14. This secures the accessory to the receptacle 12 and also electrically connects the vehicle battery (not shown) to the terminals 26, 28 which in turn are connected to the USB port 22 through the electronic components 38.

Although this invention has been disclosed and described in its preferred form with a certain degree of particularity, it is understood that the present disclosure of the preferred form is only by way of example and that numerous changes in the details of operation and in the combination and arrangement of parts may be resorted to without departing from the spirit and scope of the invention as hereinafter claimed.

I claim:

1. An accessory for a cowing vehicle having an electrical receptacle wherein the electrical receptacle includes a constantly electrically energized terminal and a ground terminal, the accessory comprising
a housing having a first end configured to be received in the electrical receptacle and a second end having an end cap providing a slot opening through the second housing end;
a fitting, in the first housing end, including a pair of spaced conductive terminals configured to make electrical connection with the energized terminal and the ground terminal when the housing is received in the electrical receptacle; and
an electronics module in the housing having
leads electrically connected to the conductive terminals on the fitting,
electronic components powered through the leads and configured to convert an input vehicle voltage into an output voltage compatible with a USB enabled device, and
a USB port connected to the electrical components and configured to deliver the output, voltage to a USB enabled device, the USB port being accessible through the slot opening through the end cap of the second housing end;
the housing including projections extending into an interior of the housing configured to captivate, stabilize and immobilize the electronic module.

2. The accessory of claim 1 wherein the fitting, module and slot in the end cap are linearly aligned.

3. The accessory of claim 1 wherein the housing and end cap are of one unitary piece.

4. The accessory of claim 1 wherein the housing comprises two mirror image halves and an end cap secured to the mirror image halves.

5. The accessory of claim 1 wherein the output voltage is 5 volt direct current.

6. The accessory of claim 1 wherein the end cap provides only one slot opening through the second housing end and wherein there is only one USB port exposed through the slot.
